(19) United States
(12) Patent Application Publication
(10) Pub. No.: US 2008/0122901 A1
(43) Pub. Date: May 29, 2008

(54) PRINTHEAD RESERVOIR WITH FILTER USED AS A CHECK VALVE

(75) Inventors: David P. Platt, Newberg, OR (US); David R. Koehler, Sherwood, OR (US); Shawn M. Close, Portland, OR (US); Michael F. Deily, Butte, MT (US); William B. Weaver, Sherwood, OR (US)

Correspondence Address: MARGER JOHNSON & MCCOLLOM, P.C. - Xerox, 210 SW MORRISON STREET, SUITE 400, PORTLAND, OR, 97204, US

(73) Assignee: XEROX CORPORATION

(21) Appl. No.: 11/564,538

(22) Filed: Nov. 29, 2006

(51) Int. Cl. B41J 2/175

(52) U.S. Cl. 347/85

(57) ABSTRACT

A printhead reservoir includes at least one ink reservoir to hold ink and at least one umbilical to deliver ink to the ink reservoir under pressure. A filter resides between the umbilical and the ink reservoir having meniscus strength sufficient enough to prevent the reservoir from draining when the pressure is removed or if a pressure is applied downstream of the filter. The filter may reside above the ink reservoir to further reduce the ink drain back. The reservoir may also include a weir plate to allow the filter to reside below the ink level.

### BACKGROUND

In an ink printer, a reservoir may hold the ink close to the nozzles or jets that deliver the ink to the print substrate such as a piece of paper. Ink is generally delivered to this reservoir via a port, and a delivery conduit of some type may feed ink to this port. For example, a solid ink printer in which the ink is melted prior to deliver to the reservoir uses a pressurized, heated umbilical to deliver melted ink to the reservoir. The ink source may reside in a position lower than the reservoir.

Solid ink printheads generally have air bubbles in the ink after being warned from a solid state. To remove this air, pressure may be applied to the system to “purge” a small amount of ink out that has air bubbles. For example, a solid ink printhead in which pressure is selectively applied to the ink reservoir via a vent port, downstream of the filter and ink delivery port.

Without a check valve of some type, if a negative pressure is applied at the ink port, such as the ink source being lower than the ink reservoir, the ink will drain out of the reservoir when the pressure from the umbilical stops and return to the ink source. The system must then ‘redeliver’ the ink to the reservoir, slowing operation of the printer. In addition, if a positive pressure is applied to the reservoir downstream of the ink delivery port, the ink will drain or spray out of the reservoir. Unfortunately, check valves increase the cost and complexity of the printhead reservoir. This in turn increases the cost and complexity of the printing system, especially in color printers that may have several colors of ink and therefore several individual reservoirs in the printhead reservoir, and printers that may have several printheads.

### SUMMARY

In one embodiment a printhead reservoir has at least one ink reservoir to hold ink, and at least one umbilical to deliver ink to the ink reservoir under pressure. A filter resides between the umbilical and the ink reservoir having meniscus strength, known in the industry as “bubble point”, sufficient enough to prevent the reservoir from draining when the pressure is removed or when there is a positive pressure on the downstream side of the filter.

In another embodiment, a printhead reservoir includes at least one ink reservoir to hold ink and at least one umbilical to deliver ink to the ink reservoir under pressure. A filter between the umbilical and the ink reservoir has a meniscus strength sufficient to prevent the reservoir from draining when the pressure is removed or when there is a positive pressure on the downstream side of the filter, the filter positioned above a level of ink in the ink reservoir.

In another embodiment a printhead reservoir has at least one ink reservoir and at least one umbilical to deliver ink under pressure to the ink reservoir, the umbilical connected to each ink reservoir at an umbilical connection. A filter bonded to the printhead reservoir at a connection point between the umbilical connection and the ink reservoir has meniscus strength sufficient to prevent the ink reservoir from draining when the pressure is removed or when there is a positive pressure on the downstream side of the filter.

### BRIEF DESCRIPTION OF THE DRAWINGS

FIG. 1 shows a back view of a printhead reservoir.

FIG. 2 shows a cross-sectional view of one embodiment of a printhead reservoir.

FIG. 3 shows a cross-sectional view of an alternative embodiment of a printhead reservoir.

### DETAILED DESCRIPTION

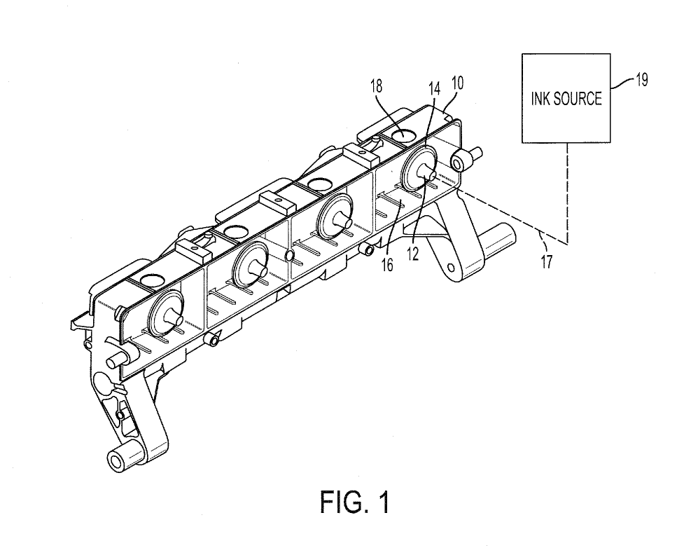

FIG. 1 shows an example of a printhead reservoir 10. The printhead reservoir, as that term is used here, includes at least one ink reservoir 16. In a print system, the printhead reservoir serves to contain the ink used by the nozzles, or jets, that spray the ink onto a printing substrate. A print system may include a printer receiving data from a user for printing, a printer employed in a fax machine, a scanner or a copying machine. The description here implies no limitation on the use of a print system. The print system transfers ink to a printing substrate such as a piece of paper or other directly printed substrate, or an intermediate transfer surface. The jets receive ink from the ink reservoirs inside the printhead reservoir.

An ink reservoir holds the ink later transported to the jets or nozzles that spray the ink on the printing substrate. In some instances, the printhead reservoir may include external components bonded onto the plates that form the ink reservoir or reservoirs. The ink reservoirs form an internal component of the printhead reservoir.

The printhead reservoir 10 in the example of FIG. 1 has four ink reservoirs such as 16. This may occur in a color printer having a reservoir for each of the colors cyan, magenta, yellow and black. Each reservoir receives ink from an ink source 16 receives ink from an ink source, such as 19. In one example, the ink source provides ink through a pressurized, heated umbilical 17. The printhead reservoir 10 may have one or more connections or interfaces with the umbilical to secure the umbilical to the printhead reservoir for transfer of the ink.

Generally, the printhead reservoir will filter the ink in some fashion to eliminate any particulates that may clog the jets or nozzles. The examples shown here use the filter as a check valve. If the ink source 19 lies below the printhead reservoir in the print system, when the system removes the pressure used to transfer ink from the source 19 to the ink reservoir 16 the reservoir will drain back into the ink source. This lowers the efficiency and the speed of the print system, as the ink source will have to re-transfer the ink back to the ink reservoir before printing can resume.

However, selection of the filter may eliminate or mitigate this problem. If the filter has sufficient meniscus strength, it acts as a check valve and prevents the ink from returning to the ink source. Once wetted with ink, the filter has a meniscus that must be overcome with pressure to cause air to flow through the filter in either direction. The ink source generally delivers the ink to the ink reservoirs under pressure, so nothing prevents the ink reservoir from receiving the ink. Without pressure in the reverse direction, however, the filter prevents the ink from draining out of the reservoir, since air cannot be pulled through it.

Solid ink printhead generally need to have the air “purged” from the system, and may do so by applying pressure to the air vent 18. Without a check valve or an upstream filter above the ink in the reservoir, the ink would exit the umbilical. With this filter, if the purge pressure is lower than the filter bubble point, the meniscus will prevent this.

The term ‘draining’ as used here means that the ink reservoir loses at least a portion, if not all, of the ink in the reservoir. A reservoir may be partially drained or completely drained; the term ‘drain’ or ‘draining’ would include both. In some cases, the reservoir will partially drain; in others the reservoir will completely drain, meaning that all ink in the reservoir returns to the ink source. Of course, ‘all ink’ takes into account that some residue of ink may remain in the reservoir or the umbilical.

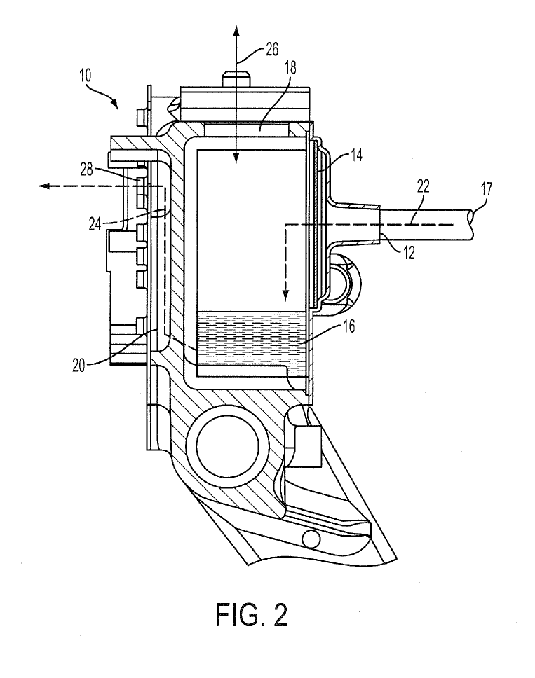

FIG. 2 shows a cross-sectional view of one example of an ink reservoir within a printhead reservoir. The printhead reservoir 10 may contain more than one ink reservoir. The ink reservoir 16 receives ink from the ink source, not shown, from the umbilical 17 through the ink port or connection 12. The ink from the ink source travels along an input ink path 22. The reservoir holds the ink until the printhead activates and draws ink through a channel 20 along a jet path 24 to the exit to the jet 28. The filter 14 filters the ink from the source, and an air vent 18 allows air to vent from the reservoir 26 to avoid pressure buildup inside the reservoir.

In this example, when the pressure from the umbilical falls off, the ink would drain out of the reservoir to the ink source without a check valve if the ink source resides in a position lower than the ink reservoir and the filter resides below the ink level. The use of a filter above the ink level in the input ink path having sufficient meniscus strength alleviates this problem. Further, the position of the filter above a level of ink in the reservoir assists in preventing the reservoir from draining.

In one embodiment, the filter consists of a stainless steel felt and mesh disc 13. However, the filter may be of any material that holds a strong enough meniscus, and may be of any shape.

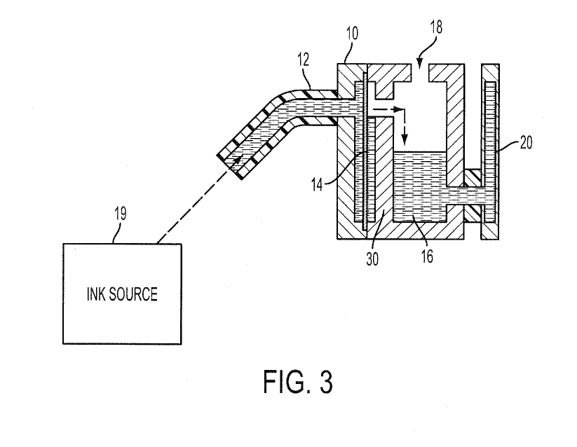

FIG. 3 shows an alternative configuration of a printhead reservoir 10. In some print systems, a lack of space or flexibility in the system layout may dictate a position for the filter below the ink level. During pressurized ink delivery, ink will fill the chamber in which the filter 14 resides. A weir plate 30 forms the chamber in which the filter resides. When the pressure falls off, and the ink source is below the ink reservoir, the amount of ink between the weir plate 30 and the ink reservoir 16 will siphon back into the umbilical 12. The ink will only partially drain in this instance, as the meniscus on the filter will hold an amount of ink corresponding to the amount of ink between the umbilical connection 12 and the filter 14.

Many other configurations may occur. Having a filter with a meniscus of a particular strength prevents draining, at least in part, of the ink reservoir. This allows the print system to function more efficiently and generally with faster output. Many different kinds of filters may function in this environment. The filter discs may bond to the back plate of the printhead reservoir in various ways. In one example, Sylgard® bonds the stainless steel filter discs to the aluminum plate, allowing a strong mechanical connection. Sylgard® provides merely one example of a bonding agent or adhesive and does not limit the scope of the application in any way. In other examples, the printhead reservoir plate may have a compartment or other feature to allow insertion of the filter without a bonding agent.

In this manner, a filter in the ink input path can act as a check valve. This eliminates the need for separate check valves, reducing the cost and complexity of the print system. The filter may reside above or under the ink level, allowing the filter to function as a check valve in different configurations.

The use of a filter as a check valve may have a broader application than just in print heads. Any fluid reservoir that employs a filter may benefit from moving the filter to an external position in order to use the filter as a check valve. The filter position should be in a fluid input path to the reservoir, rather than in an output fluid path.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A printhead reservoir, comprising:
at least one ink reservoir to hold ink;
at least one umbilical to deliver ink to the ink reservoir under pressure; and
a filter between the umbilical and the ink reservoir having meniscus strength sufficient enough to prevent the reservoir from draining when the pressure is one of either removed or applied downstream of the filter.

2. The printhead reservoir of claim 1, wherein at least one ink reservoir comprises one ink reservoir for each of four different colors of ink.

3. The printhead reservoir of claim 2, each ink reservoir having an umbilical.

4. The printhead reservoir of claim 2, each ink reservoir having a filter.

5. The printhead reservoir of claim 1, wherein the filter comprises a disc filter.

6. The printhead reservoir of claim 5, wherein the disc filter comprises a disc of filter material bonded to a metal plate.

7. The printhead reservoir of claim 1, wherein the umbilical comprises a heated umbilical.

8. A printhead reservoir, comprising:
at least one ink reservoir to hold ink;
at least one umbilical to deliver ink to the ink reservoir under pressure; and
a filter between the umbilical and the ink reservoir having meniscus strength sufficient to prevent the reservoir from draining when the pressure is one of either removed or applied downstream of the filter, the filter positioned above a level of ink in the ink reservoir.

9. The printhead reservoir of claim 8, the filter comprising a disc filter.

10. The printhead reservoir of claim 9, the disc filter bonded to a metal plate.

11. The printhead of claim 8, the ink reservoir further comprising at least one hole in a top of the reservoir to allow air to escape.

12. The printhead of claim 8, the filter having a bubble point of approximately 15 in H₂O.

13. The printhead of claim 8, at least one ink reservoir comprising four ink reservoirs, each ink reservoir fed by an umbilical through a filter.

14. The printhead of claim 8, the filter being bonded onto the printhead reservoir.

15. The printhead reservoir of claim 8, the filter comprising a disc filter.

16. A printhead reservoir, comprising:
at least one ink reservoir to hold ink;
a weir plate in each ink reservoir;
at least one umbilical to deliver ink to the ink reservoir under pressure; and
a filter between the umbilical and the ink reservoir having meniscus strength sufficient to prevent the reservoir from draining when the pressure is removed.

17. The printhead of claim 16, the ink reservoir further comprising at least one hole in a top of the reservoir to allow air to escape.

18. The printhead of claim 16, the filter having a bubble point of at least 15 in H₂O.

19. The printhead of claim 16, at least one ink reservoir comprising four ink reservoirs, each ink reservoir fed by an umbilical through a filter.

20. The printhead of claim 16, the filter being bonded onto the printhead reservoir.

21. A fluid reservoir, comprising:
at least one fluid reservoir;
at least one umbilical to deliver fluid to the fluid reservoir, the umbilical connected to each fluid reservoir at an umbilical connection;
a filter bonded to the fluid reservoir at a connection point between the umbilical connection and the fluid reservoir, the filter having meniscus strength sufficient to prevent the fluid reservoir from draining when the pressure is one of either removed or applied downstream of the filter.

22. The fluid reservoir of claim 21, the filter comprising a disc filter having a disc of filter material bonded to the fluid reservoir.

23. The fluid reservoir of claim 21, the filter having meniscus strength of approximately 15 in H₂O.
